(19) United States
(12) Patent Application Publication
(10) Pub. No.: US 2018/0213848 A1
(43) Pub. Date: Aug. 2, 2018

(54) PASSWORD CONTROL METHOD FOR ELECTRONIC CIGARETTE, APPARATUS AND SYSTEM, AND ELECTRONIC CIGARETTE

(71) Applicant: JOYETECH EUROPE HOLDING GMBH, Zug (CH)

(72) Inventor: WEI-HUA QIU, ChangZhou (CN)

(21) Appl. No.: 15/937,885

(22) Filed: Mar. 28, 2018

Related U.S. Application Data
(63) Continuation-in-part of application No. PCT/CN2016/098419, filed on Sep. 8, 2016.

(30) Foreign Application Priority Data
Sep. 28, 2015 (CN) 201510624183.9

(51) Int. Cl. A24F 47/00; G06F 21/35; G06F 21/36

(52) U.S. Cl. CPC A24F 47/008; G06F 21/36; G06F 21/35

(57) ABSTRACT

An electronic cigarette control method is disclosed, based on a user who desires to smoke inputting a password for matching a reference password. The method comprises a reference password being sent by a terminal in communication with the electronic cigarette, and a user password being received for verification against the reference password. The function of a control switch of the electronic cigarette to trigger the atomizer of the electronic cigarette to start operating according to the operation of the user is activated if the user is verified, otherwise the function is not activated. The present disclosure further provides an electronic cigarette control device, an electronic cigarette control system, and an electronic cigarette. Unauthorized usage by others is thus prevented, thereby making electronic cigarette safer and hygienic.

### FIELD

The present disclosure relates to an electronic cigarette, and more particularly to an electronic cigarette control method, an electronic cigarette control apparatus, an electronic cigarette control system, and an electronic cigarette.

### BACKGROUND

Electronic cigarettes usually have a physical control switch, such as a button, which can be used to activate an atomizer of the electronic cigarette as long as the button is operated, during which time the user can inhale.

However, the current electronic cigarette doesn't have protection function for different groups of people. Anyone can get the electronic cigarette and operate the control switch, to start inhaling. For younger children, it is easy to smoke, which brings certain harm to children and hurts their safety and health. Even adults, if someone else gets the electronic cigarette and inhales, the user health of the electronic cigarette cannot be ensured.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of the application environment of an embodiment of an electronic cigarette control method.

FIG. 2 is a flowchart of an electronic cigarette control method in a first embodiment.

FIG. 3 is a flowchart of an electronic cigarette control method in a second embodiment.

FIG. 4 is a flowchart of an electronic cigarette control method in a third embodiment.

FIG. 5 is a block diagram of an electronic cigarette control apparatus in a first embodiment.

FIG. 6 is a block diagram of an electronic cigarette control apparatus in a second embodiment.

FIG. 7 is a block diagram of an electronic cigarette control system.

### DETAILED DESCRIPTION

The present disclosure, including the accompanying drawings, is illustrated by way of examples and not by way of limitation. In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series, and the like.

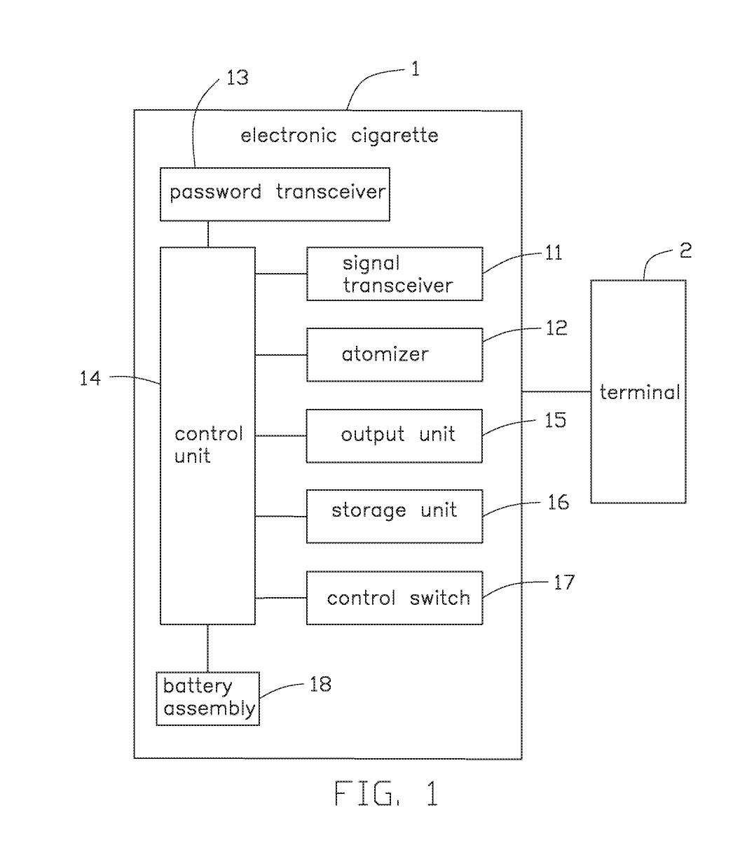

FIG. 1 shows the application environment of an embodiment of an electronic cigarette control method. The electronic cigarette control method is applied in an electronic cigarette 1 or a terminal 2. The electronic cigarette 1 includes a signal transceiver 11, an atomizer 12, a password transceiver 13, a control unit 14, an output unit 15, a storage unit 16, a control switch 17, and a battery assembly 18. The signal transceiver 11 can communicate with the terminal 2 in a wired or wireless connection, thus data can be transmitted between the electronic cigarette 1 and the terminal 2. The terminal 2 includes but is not limited to mobile phones, smart watches, smart bracelet, smart TV, intelligent router, tablet computer, laptop, and other electronic devices.

The atomizer 12 is configured to atomize liquid tobacco stored in the electronic cigarette 1 to imitate real smoke according to inhaling airflows detected by an airflow senor of the electronic cigarette 1. The password transceiver 13 is configured to receive a password for verification from a user. Specifically, the password transceiver 13 can be a keyboard assembly or a touch screen assembly to receive a password for verification. The control unit 14 electrically connects to the signal transceiver 11, the atomizer 12, the password transceiver 13, the output unit 15, the storage unit 16, the control switch 17, and the battery assembly 18, to achieve the control function. The output unit 15 is configured to output an indicator message used to remind the user according to instructions of the control unit 14. The storage unit 16 is configured to store and read data, such as storing passwords. The control switch 17 is configured to trigger the atomizer 12 to start or stop operating according to the user. The battery assembly 18 is configured to supply power to all components of the electronic cigarette 1.

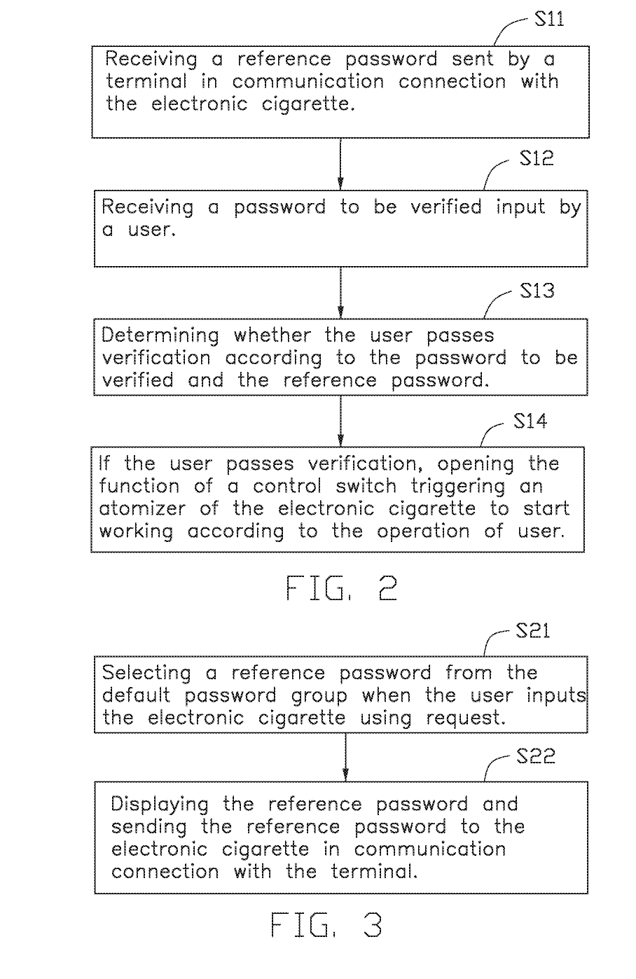

FIG. 2 is a flowchart of an electronic cigarette control method in a first embodiment. In the illustrated embodiment, the electronic cigarette control method is applied in the electronic cigarette 1. The electronic cigarette control method includes following steps:

In step S11, receiving a reference password sent by the terminal 2 in communication with the electronic cigarette 1;

In step S12, receiving the password for verification input by a user;

In step S13, determining whether the user is verified or not verified according to the password for verification and the reference password;

In step S14, if the user is verified, activating the function of the control switch 17 to trigger the atomizer 12 of the electronic cigarette 1 to start operating according to the user's operation.

In the illustrated embodiment, before smoking, the user is verified or not verified according to the input password for verification and the received reference password sent by the terminal 2. Only when the user is verified, can the function of the control switch 17 of the electronic cigarette 1 be activated, to trigger the atomizer 12 to start operating according to the user's operation. Unauthorized users can thus be prevented from using the device, thereby making electronic cigarettes safer and hygienic.

In other embodiments, the details of the steps are as follows.

The reference password in step S11 is selected by the terminal 2 from a password group and sent to electronic cigarette 1. Specifically, the terminal 2 presets a password group according to the user's operation. The password group includes at least one reference password. The reference password can be numbers, letters, or combinations of numbers and letters. Then, the terminal 2 stores the preset password group in a memorizer of the terminal 2. When the user needs to use the electronic cigarette 1, the user has to input to the terminal 2 a request to use the electronic cigarette 1. After the terminal 2 receives the using request of the electronic cigarette 1, the terminal 2 selects a reference password from the preset password group according to a preset principle, such as random, or certain formula, and so on. Then, the terminal 2 displays the reference password, and sends the reference password to the electronic cigarette 1. In the step S11, the electronic cigarette receives the reference password. The reference password also can be stored in the storage unit 16.

The user can input a password for verification to the password transceiver 13 of the electronic cigarette 1 according to the reference password displayed in the terminal 2. In the step S12, the electronic cigarette 1 receives the password for verification.

In the step S13, the user is verified or not verified. Specifically, in the step S13, the input password for verification is determined whether matches the reference password. If the input password is same as the reference password, the user is verified. If the input password is not same as the reference password, the user fails to pass the verification.

In the step S13, an indicator message indicating the verification result of the user is output, or an inform instruction is sent to the terminal 2 to trigger the terminal 2 to output the indicator message indicating the verification result. The verification result includes validation or non-validation. The indicator message is output as voice, or picture, or light, or vibration. Specifically, the output unit 15 can include at least one of voice prompting unit, screen displaying unit, prompting light unit, and vibration prompting unit.

If the user is verified, then in step S14, the function of the control switch 17 is activated to trigger the atomizer 12 to start operating according to the user's operation. Specifically, before activating the function of the control switch 17 to trigger the atomizer 12 to start operating according to the user's operation, the function is in a blocked state. In the blocked state, the atomizer 12 will not start operating, even though the user opens the control switch 17. When the function of the control switch 17 is activated in the step S14, if the user opens the control switch 17, the atomizer 12 will start operating.

Referring to FIG. 3, the present disclosure provides a second embodiment of an electronic cigarette control method. In the illustrated embodiment, the electronic cigarette control method is applied in the terminal 2. The electronic cigarette control method includes following steps.

In step S21, selecting a reference password from a preset password group when the user inputs a request to use the electronic cigarette;

In step S22, displaying the reference password and sending the reference password to the electronic cigarette 1 in communication with the terminal 2. Specifically, in step S22, the reference password can be scrolled in a display in a certain time interval.

The details of the step S21 and the step S22 can be referenced in the detailed description of the step S11 in the first embodiment.

In addition, in the step S13 of the first embodiment, when executing the step of sending the inform instruction to the terminal 2 to trigger the terminal 2 to output the indicator message indicating the verification result, after sending the reference password to the electronic cigarette 1, the step of receiving the inform instruction sent by the electronic cigarette 1, and outputting the indicator message indicating the verification result in the step S22 is executed. The verification result includes validation or non-validation. The indicator message can be output as voice, picture, light, or vibration.

A third embodiment of an electronic cigarette control method is illustrated as follows.

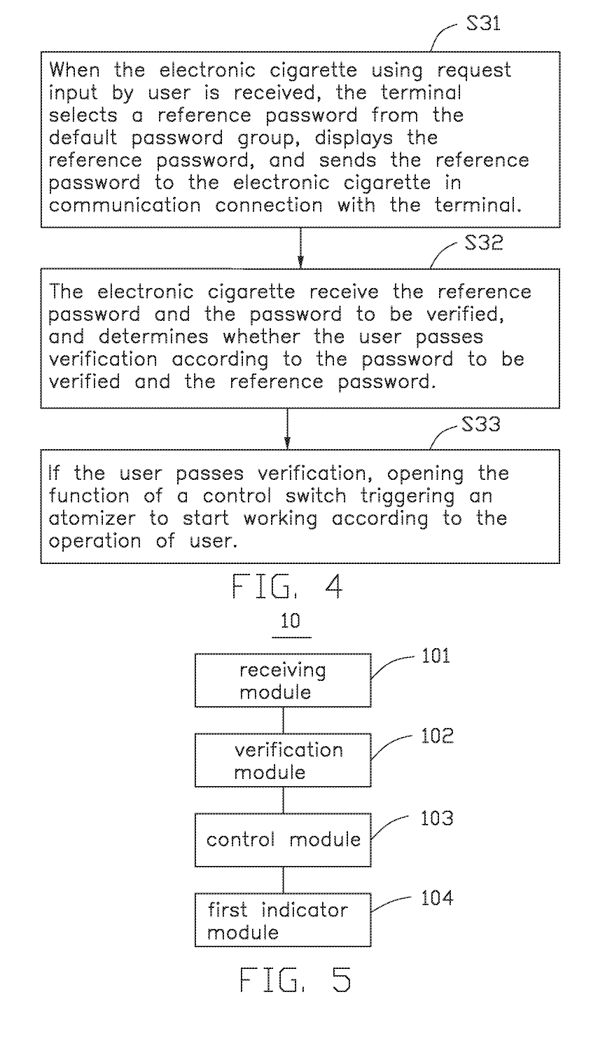

Referring to FIG. 4, the third embodiment provides an electronic cigarette control method, and the electronic cigarette control method includes following steps.

In step S31, when the request to use the electronic cigarette 1 input by the user is received, the terminal 2 selects a reference password from a preset password group and displays the reference password, and sends the reference password to an electronic cigarette 1 in communication with the terminal 2;

In step S32, the electronic cigarette 1 receives the reference password and the input password for verification, and determines whether the user is verified or not according to the input password and the reference password. In addition, in the step S32, after the electronic cigarette 1 makes a determination as to whether the user is verified or not, an indicator message indicating the verification result is output, or an inform instruction is sent to the terminal 2 to trigger the terminal 2 to output the indicator message. The verification result includes validation or non-validation. If the electronic cigarette 1 executes the step of sending an inform instruction to the terminal 2 to trigger the terminal 2 to output the indicator message, then the terminal 2 further receives the inform instruction sent by the electronic cigarette 1 corresponding the verification result, and outputs the indicator message as to verification or non-verification in the step S32. The indicator message can be output as voice, or picture, or light, or vibration.

In step S33, if the user is verified, the electronic cigarette 1 activates the function of the control switch 17 to trigger the atomizer 12 of the electronic cigarette 1 to start operating according to the user's operation.

Referring to FIG. 5, the present disclosure provides an electronic cigarette control apparatus 10 of a first embodiment. The electronic cigarette control apparatus 10 operates in an electronic cigarette 1. The electronic cigarette control apparatus 10 includes a receiving module 101, a verification module 102, a control module 103, and a first indicator module 104.

The receiving module 101 is configured to receive a reference password sent by a terminal 2 in communication with the electronic cigarette 1, and to receive a password for verification input by the user.

The verification module 102 determines whether the user is verified or not verified according to the input password for verification and the reference password. Specifically, the verification module 102 determines whether the input password is same as the reference password or not. If the input password is same as the reference password, the user is verified.

The control module 103 is configured to open the function of a control switch 17 of the electronic cigarette 1 triggering an atomizer 12 to start operating according to the user's operation when the user is verified.

The first indicator module 104 is configured to output an indicator message indicating the verification result, or to send an inform instruction to the terminal 2 to trigger the terminal 2 to output the indicator message accordingly. The verification result includes validation or non-validation. The indicator message is output as voice, picture, light, or vibration.

Each of these modules refers to a computer program or program segment that performs one or more specific functions. In addition, the distinction between these modules does not mean that the actual program code must be separate.

The specific operating process of the above modules can refer to the electronic cigarette control method of the first embodiment.

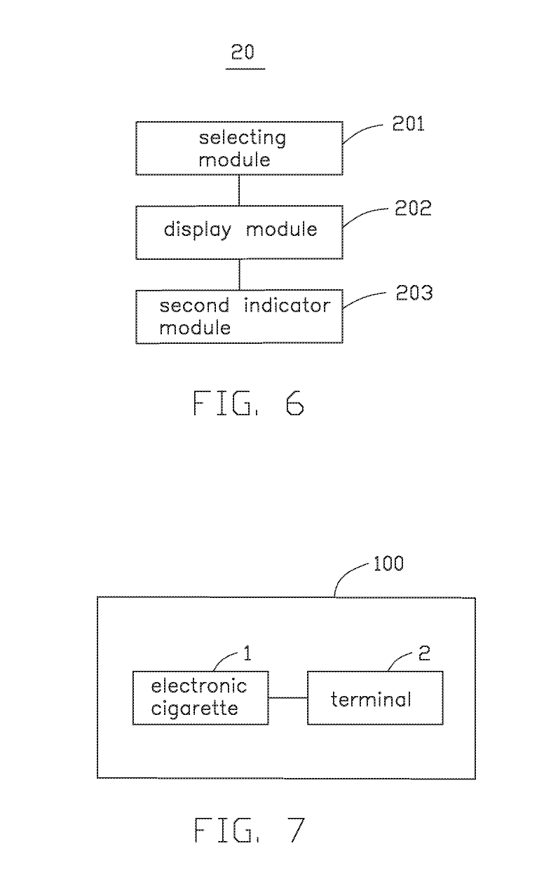

Referring to FIG. 6, the present disclosure provides an electronic cigarette control apparatus 20 of a second embodiment. The electronic cigarette control apparatus 20 operates in a terminal 2. The electronic cigarette control apparatus 20 may include a selecting module 201, a display module 202, and a second indicator module 203.

The selecting module 201 is configured to select a reference password from a preset password group when a request to use the electronic cigarette 1 is received.

The display module 202 is configured to display the reference password, and send the reference password to a terminal 2 in communication with the electronic cigarette 1. The display module 202 can scroll the reference password in a certain time interval on a display device.

The second indicator module 203 is configured to receive an inform instruction of the verification result sent by the electronic cigarette 1, and output an indicator message accordingly. The verification result includes validation or non-validation. The indicator message is output as voice, or picture, or light, or vibration.

The specific operating process of the above modules can refer to the electronic cigarette control method of the second embodiment.

An embodiment of a terminal of the present disclosure. The terminal includes a transceiver and a controller.

The transceiver is configured to receive a reference password sent by the terminal in communication with the electronic cigarette.

The transceiver is further configured to receive a password for verification input by a user.

The controller, is configured to determine whether the user is verified or not according to the input password and the reference password.

When the user is verified, the controller is configured to activate the function of a control switch of the electronic cigarette to trigger an atomizer of the electronic cigarette to start operating according to the user's operation.

Preferably, the controller is configured to determine whether the input password is same as the reference password or not, if the input password is same as the reference password, the user is verified.

Preferably, after the step of determining whether the user is verified or not according to the input password and the reference password, the controller is configured to output an indicator message indicating the verification result; or sending, from the electronic cigarette, an inform instruction to the terminal to trigger the terminal to output an indicator message accordingly. The verification result comprises validation or non-validation

The present disclosure provides an electronic cigarette 1 of an embodiment. The electronic cigarette 1 includes a signal transceiver 11, an atomizer 12, a password transceiver 13, a control unit 14, and an output unit 15.

The signal transceiver 11 is configured to be in communication with the terminal 2, and to receive a reference password sent by the terminal 2.

The password transceiver 13 is configured to receive a password for verification input by the user.

The control unit 14 is electrically connected to the signal transceiver 11 and the password transceiver 13. The control unit 14 determines whether or not the user is verified according to the input password and the reference password. In addition, if the user is verified, the control unit 14 is configured to activate the function of a control switch 17 of the electronic cigarette 1 to trigger the atomizer 12 to start operating according to the user's operation.

The output unit 15 is electrically connected to the control unit 14. The output unit 15 is configured to output an indicator message indicating the verification result; or configured to send an inform instruction to the terminal 2 to trigger the terminal 2 to output an indicator message accordingly. The verification result includes validation or non-validation. The output unit 15 may include at least one of voice prompting unit, screen displaying unit, prompting light unit, and vibration prompting unit. The indicator message is output as voice, or picture, or light, or vibration.

Referring to FIG. 7, the present disclosure provides an electronic cigarette control system 100 of an embodiment. The electronic cigarette control system 100 includes at least one of the electronic cigarette 1 of a previous embodiment, and at least one of the terminal 2 of the electronic cigarette control apparatus 20 of a previous embodiment.

The specific operating process of the electronic cigarette 1 and the terminal 2 of the electronic cigarette control system 100 can refer to the electronic cigarette control method of the third embodiment.

A computer readable storage medium or more than computer readable storage medium is included in the device. The computer readable storage medium stores computer executable instructions. The computer readable storage medium is nonvolatile storage, such as compact disc, hard disk, or flash memory. The computer executable instructions are configured to let a computer or a similar computing device achieve the steps of the electronic cigarette control method above mentioned.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. An electronic cigarette control method, comprising following steps:
receiving, at an electronic cigarette, a reference password sent by a terminal in communication with the electronic cigarette;
receiving, at the electronic cigarette, a password for verification input by a user;
determining, at the electronic cigarette, whether the user is verified or not according to the input password and the reference password;
wherein if the user is verified, the electronic cigarette activates the function of a control switch of the electronic cigarette to trigger an atomizer of the electronic cigarette to start operating according to the user's operation.

2. The electronic cigarette control method as claimed in claim 1, wherein the step of determining whether the user is verified or not according to the input password and the reference password comprises:
determining, at the electronic cigarette, whether the input password is same as the reference password or not, if the input password is same as the reference password, the user is verified.

3. The electronic cigarette control method as claimed in claim 1, wherein after the step of determining whether the user is verified or not according to the input password and the reference password, the method further comprises:
outputting, at the electronic cigarette, an indicator message indicating the verification result, wherein the verification result comprises validation or non-validation; or
sending, from the electronic cigarette, an inform instruction to the terminal to trigger the terminal to output an indicator message accordingly.

4. The electronic cigarette control method as claimed in claim 3, wherein the indicator message is in a form of by voice, or picture, or light or vibration.

5. An electronic cigarette control method, comprising:
selecting, at the terminal, a reference password from a preset password group when the user input an request to use the electronic cigarette;
displaying, at the terminal, the reference password; and
sending, from the terminal, the reference password to the electronic cigarette in communication with the terminal.

6. The electronic cigarette control method as claimed in claim 5, wherein the step of displaying the reference password comprise:
scrolling, at the terminal, the reference password at a certain time interval on a display device.

7. The electronic cigarette control method as claimed in claim 5, wherein the method further comprises:
receiving, at the terminal, an inform instruction of the verification result sent by the electronic cigarette, and outputting the indicator message accordingly,
wherein, the verification result comprises validation or non-validation.

8. The electronic cigarette control method as claimed in claim 7, wherein the indicator message is in a form of as voice, or picture, or light or vibration.

9. An electronic cigarette, comprising:
a signal transceiver, configured to be in communication with the terminal, and receive a reference password from the terminal;
a password transceiver, configured to receive a password for verification input by a user;
a control unit connected with the signal transceiver and the password transceiver, where in the control unit configured to determine whether the user is verified or not according to the input password and the reference password, and to activate the function of a control switch of the electronic cigarette to trigger the atomizer of the electronic cigarette to start operating according to the user's operation when the user is verified.

10. The electronic cigarette as claimed in claim 9, wherein the electronic cigarette further comprises an output unit electrically connected with the control unit, and the output unit configured to:
output an indicator message indicating the verification result, wherein, the verification result comprise validation or non-validation; or
send an inform instruction to the terminal to trigger the terminal to send out the indicator message accordingly,

11. The electronic cigarette as claimed in claim 10, wherein the output unit is at least one of voice prompting unit, screen displaying unit, prompting light unit, and vibration prompting unit, the indicator message is in a form of voice, or picture, or light, or vibration.
